(19) United States
(12) Patent Application Publication
(10) Pub. No.: US 2021/0188507 A1
(43) Pub. Date: Jun. 24, 2021

(54) SHEET MATERIAL AND ALCOHOL VAPORIZATION AGENT PACKAGE USING SHEET MATERIAL

(71) Applicant: JXTG Nippon Oil & Energy Corporation, Chiyoda-ku, Tokyo (JP)

(72) Inventors: Tomoyuki OKAMURA, Tokyo (JP); Keiichi OOTSUBO, Sanbu-gun (JP); Masahiro WAKAYAMA, Sanbu-gun (JP)

(21) Appl. No.: 16/757,764

(22) PCT Filed: Nov. 5, 2018
(86) PCT No.: PCT/JP2018/041001

§ 371 Date: Apr. 20, 2020

(30) Foreign Application Priority Data
Nov. 6, 2017 (JP) 2017-213897

(51) Int. Cl. B65D 65/40; B32B 5/02; B32B 27/34; B32B 27/12

(52) U.S. Cl. CPC B65D 65/40; B32B 5/024; B32B 5/022; B32B 27/34; B32B 2439/46; B32B 2307/7265; B32B 2255/10; B32B 2255/26; B32B 27/12

(57) ABSTRACT

A sheet material is provided which includes a reticular structure, a polyamide-based resin film laminated on one face of the reticular structure, and a resin layer formed on a face of the polyamide-based resin film, the face being on the opposite side of the reticular structure. The resin layer prevents precipitation of oligomers included in the resin film on the surface of the sheet material when alcohol permeates through the polyamide-based resin film.

### TECHNICAL FIELD

The present invention relates to a sheet material that is gas-permeable and permeates alcohol vapor in particular, and an alcohol vaporization agent package that uses this sheet material.

Priority is claimed on Japanese Patent Application No. 2017-213897, filed on Nov. 6, 2017, the content of which is incorporated herein by reference.

### BACKGROUND ART

In order to prevent putrefaction, degeneration, deterioration, and the like of processed food products, packages having an alcohol vaporization agent encapsulated therein, that is, so-called alcohol vaporization agent packages, are used. Packages of this kind are accommodated, together with processed food products, in the external packaging bags of the food products. For example, Patent Document 1 discloses a packaging sheet obtained by laminating a nylon film and a nonwoven fabric, and a packaging bag for an alcohol vaporization agent produced using the packaging sheet.

### CITATION LIST

### Patent Document

Patent Document 1: Japanese Unexamined Patent Application, First Publication No. 2003-211604

### DISCLOSURE OF INVENTION

### Technical Problem

In regard to the packaging sheet disclosed in Patent Document 1, a nylon film constitutes the outermost surface layer that comes into contact with food. In a case in which an alcohol vaporization agent is packaged using this sheet material, oligomers included in the nylon film exude from the nylon film together with alcohol when the alcohol permeates through the sheet material, and the oligomers may precipitate out as a white powder on the surface of the sheet material. The oligomers produced from nylon are harmless; however, since the alcohol vaporization agent package is accommodated with food in an external packaging bag, when oligomers precipitate out on the surface of the nylon film, there is a possibility that those oligomers may stick to the foodstuffs. When oligomers stick to the foodstuffs, even though the oligomers are harmless, the oligomers give an impression of not being hygienic to the consumers, and there is a risk that such an impression may significantly lower the product value of foodstuffs.

The present invention was achieved in view of such circumstances, and it is an object of the invention to prevent oligomers from precipitating out from the sheet material to the outside, from adhering to the article (for example, a food product) to be packed together by the sheet material, and from lowering the value of the article.

### Solution to Problem

A first embodiment of the invention is a sheet material including a sheet-like substrate material; a polyamide-based resin film laminated on one face of the substrate material; and a resin layer formed on a face of the polyamide-based resin film, the face being on the opposite side of the substrate material, and the resin layer prevents precipitation of oligomers included in the polyamide-based resin film.

A second embodiment of the invention is an alcohol vaporization agent package including a package main body processed into a bag shape; and an alcohol vaporization agent enclosed in the package main body, and the sheet material has a sheet-like substrate material, a polyamide-based resin film laminated on one face of the substrate material, and a resin layer formed on a face of the polyamide-based resin film, the face being on the opposite side of the substrate material, while the resin layer prevents precipitation of oligomers included in the polyamide-based resin film on the sheet material surface when alcohol vaporizing from the alcohol vaporization agent permeates through the polyamide-based resin film.

According to the first or second embodiment described above, it is preferable that the resin layer includes a Medium or a fluororesin. Furthermore, the substrate material may be a woven fabric or a nonwoven fabric. In addition, the nonwoven fabric may be a reticular structure.

### Advantageous Effects of Invention

According to the invention, a resin layer is formed on a face of a polyamide-based resin film, the face being on the opposite side of the substrate material. Therefore, when alcohol permeates through the sheet material, even if oligomers that are included in the polyamide-based resin film exude from the polyamide-based resin film along with the alcohol, the resin layer formed on the surface of the polyamide-based resin film prevents permeation of the oligomers while permeating the alcohol. Therefore, precipitation of the oligomers on the surface of the sheet material is prevented. Thereby, when an alcohol vaporization agent package is produced using the sheet material of the invention, oligomers do not stick to an article (for example, a food product) to be packed together in the alcohol vaporization agent package and do not therefore lower the value of the article.

### BRIEF DESCRIPTION OF DRAWINGS

FIG. 1A is a perspective view showing a sheet material according to a first embodiment of the invention.

FIG. 1B is a schematic cross-sectional view of the sheet material shown in FIG. 1A.

FIG. 2A is a schematic diagram showing, in a stepwise manner, a method for producing a sheet material.

FIG. 2B is a schematic diagram showing, in a stepwise manner, the method for producing a sheet material.

FIG. 2C is a schematic diagram showing, in a stepwise manner, the method for producing a sheet material.

FIG. 2D is a schematic diagram showing, in a stepwise manner, the method for producing a sheet material.

FIG. 2E is a schematic diagram showing, in a stepwise manner, the method for producing a sheet material.

FIG. 3 is a plan view showing a first reticular structure that can be employed as a material for the sheet material.

FIG. 4A is a perspective view showing the configuration of a uniaxially oriented body that constitutes the reticular structure shown in FIG. 3.

FIG. 4B is a perspective view showing a magnification of a portion of the uniaxially oriented body shown in FIG. 4A.

FIG. 5A is a perspective view showing the configuration of another uniaxially oriented body that constitutes the reticular structure shown in FIG. 3.

FIG. 5B is a perspective view showing a magnification of a portion of the uniaxially oriented body shown in FIG. 5A.

FIG. 6 is a perspective view showing a second reticular structure that can be employed as a material for the sheet material.

FIG. 7A is a perspective view showing an alcohol vaporization agent package according to a second embodiment of the invention.

FIG. 7B is a cross-sectional view of the alcohol vaporization agent package shown in FIG. 7A.

FIG. 8A is a schematic diagram showing, in a stepwise manner, a method for producing an alcohol vaporization agent package.

FIG. 8B is a schematic diagram showing, in a stepwise manner, the method for producing an alcohol vaporization agent package.

FIG. 8C is a schematic diagram showing, in a stepwise manner, the method for producing an alcohol vaporization agent package.

### BEST MODE FOR CARRYING OUT THE INVENTION

### First Embodiment

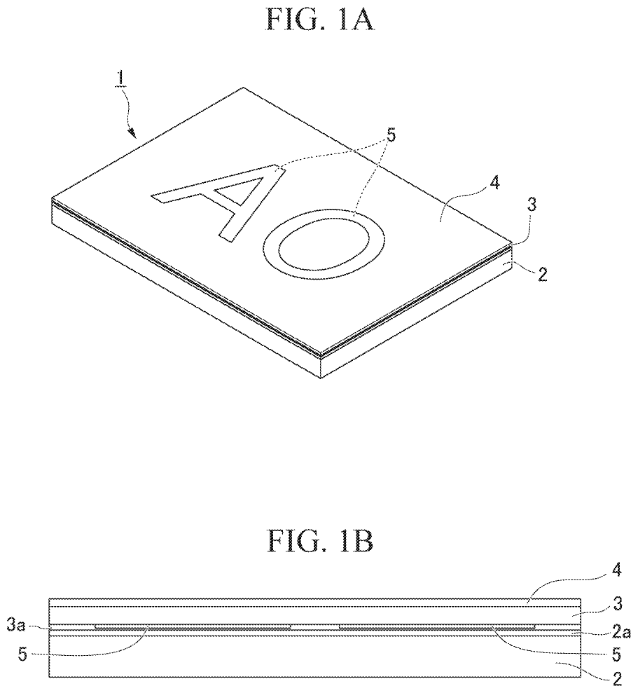

A first embodiment according to the invention will be explained by describing the embodiment in FIG. 1A to FIG. 5B.

FIGS. 1A and 1B show an example of the sheet material according to the present embodiment. FIG. 1A is a perspective view of sheet material 1, and FIG. 1B is a schematic cross-sectional view showing a fractured portion of FIG. 1A.

Sheet material 1 is used for a package that packs a solid alcohol vaporization agent and is accommodated together with foodstuffs in an external packaging bag, and the sheet material 1 has a sheet-like reticular structure 2; a polyamide-based resin film 3 adhered to one face of the reticular structure 2; and a resin layer 4 formed on a face of the polyamide-based resin film 3, the face being on the opposite side of the reticular structure 2. The reticular structure 2 plays the role of a substrate material of the sheet material 1. The polyamide-based resin film 3 permeates vaporized alcohol while retaining a packaged alcohol vaporization agent. The resin layer 4 is such that when alcohol permeates through the polyamide-based resin film 3, even if oligomers that are included in the polyamide-based resin film 3 exude from the polyamide-based resin film 3 along with the alcohol, the resin layer 4 prevents precipitation of the oligomers on the surface of the sheet material 1.

Meanwhile, in the present embodiment, a reticular structure 2 that is a nonwoven fabric is employed as the substrate material; however, it is also acceptable to employ a reticular structure that is a woven fabric as the substrate material, as long as the woven fabric has a similar function.

(Reticular Structure)

The reticular structure 2 includes two or more uniaxially oriented bodies, each uniaxially oriented body including a thermoplastic resin layer; and a linear low-density polyethylene layer laminated on at least one face of this thermoplastic resin layer. The two or more uniaxially oriented bodies are at least either of uniaxially oriented reticular films or uniaxially oriented tapes. These two or more uniaxially oriented bodies are laminated by means of an adhesive layer or are woven such that the respective axes of orientation thereof intersect with each other. The linear low-density polyethylene layer functions as an adhesive layer for adhering two or more uniaxially oriented bodies. Specific examples of the reticular structure 2 will be described in detail below however, the reticular structure 2 is approximately configured as follows.

A uniaxially oriented body includes a first linear low-density polyethylene layer laminated on one face of a thermoplastic resin layer, and a second linear low-density polyethylene layer laminated on the other face of this thermoplastic resin layer. These first and second linear low-density polyethylene layers may be formed from linear low-density polyethylenes having long-chain branches in the molecular chain. In a case in which the reticular structure 2 is formed by weaving two or more uniaxially oriented bodies, the linear low-density polyethylene layers may be formed from linear low-density polyethylenes polymerized using metallocene catalysts.

For instance, the first and second linear low-density polyethylene layers are respectively formed from a linear low-density polyethylene having a melt flow rate (MFR) of 0.5 to 10 g/10 min and a density of 0.900 to 0.930 g/cm³. The reticular structure 2 in this case satisfies characteristics such as a weight per unit area of 5 to 70 g/m², a thickness of the linear low-density polyethylene layer of 2 to 10 μm, an adhesive force between the uniaxially oriented bodies of 10 to 60 N, and a tensile strength of 20 to 600 N/50 nm.

(Polyamide-Based Resin Film)

It is preferable that the polyamide-based resin film 3 can be thermally compressed with the reticular structure 2 and has necessary air permeability. Regarding the necessary air permeability, for example, it is preferable to secure a permeability of volatilized alcohol of 20 g/m²·24 h·25° C.·84% R H or higher. For the polyamide-based resin film 3, for example, a uniaxially or biaxially stretched nylon film, or an unstretched nylon can be used. Examples of a biaxially stretched nylon film include BARDEN (registered trademark) manufactured by Toyobo Co., Ltd.

The face of the polyamide-based resin film 3 that comes into contact with the reticular structure 2 can be subjected to printing. When the polyamide-based resin film 3 is transparent or translucent, the printed information can also be visually recognized through the face on the opposite side of the face that has been subjected to printing. For the printing, an ink that is generally used for printing on packaging materials, which conforms to the “Voluntary Regulations Concerning Printing Inks for Food Packaging Materials”, NL Regulations, enacted by Japan Printing Ink Makers Association, can be used.

Since the polyamide-based resin film 3 is compressed to the reticular structure 2 after being subjected to printing on the face that comes into contact with the reticular structure 2, the ink used for the printing will not be exposed on the surface of the sheet material 1. Therefore, even if the package is stored in an external packaging bag together with foodstuffs, the ink for printing will not come into contact with the foodstuffs.

Polar functional groups are introduced into the face of the reticular structure 2 in contact with the polyamide-based resin film 3, and the face of the polyamide-based resin film 3 in contact with the reticular structure 2, by subjecting the faces to a corona treatment, and on the surfaces of the reticular structure 2 and the polyamide-based resin film 3 that face each other, modification layers 2a and 3a having increased hydrophilicity as a result of introduction of polar functional groups are respectively formed. When the modification layers 2a and 3a are formed, the adhesiveness between the reticular structure 2 and the polyamide-based resin film 3 is enhanced. Meanwhile, it is not necessary to carry out the surface modification by a corona treatment in both the reticular structure 2 and the polyamide-based resin film 3, and the surface modification may be carried out on any one of them.

(Resin Layer)

The resin layer 4 is formed by applying a resin material on a face of the polyamide-based resin film 3, the face being on the opposite side of the face that is in contact with the reticular structure 2. Regarding the resin material, for example, an ink including a Medium as a main component, or a resin coating material including fluorine is employed. A Medium is a coating material that includes an achromatic pigment and forms a transparent coating film after being dried. It is preferable that the resin layer 4 is formed on the surface of the polyamide-based resin film 3, not partially but over the entire surface. Furthermore, the amount of coating of the ink that forms the resin layer 4 is preferably 2 to 20 g/m².

Ina case in which an alcohol vaporization agent package for food preservation is produced using a sheet material 1, the resin layer 4 formed on a face of the polyamide-based resin film 3, the face being on the opposite side of the reticular structure 2, is arranged to be exposed to the food. That is, when the package is configured by arranging the reticular structure 2 on the inner side and the resin layer 4 on the outer side, in a case in which the alcohol vaporizing from the alcohol vaporization agent enclosed in the package permeates through the polyamide-based resin film 3, even if oligomers included in the polyamide-based resin film 3 exude from the polyamide-based resin film 3 along with the alcohol, the resin layer 4 formed on the outer surface of the package blocks permeation of the oligomers while permeating alcohol. Therefore, precipitation of the oligomers on the surface of the sheet material 1 is prevented. Therefore, a white precipitated powder of the oligomers will not escape from the package of the sheet material 1 and stick to the foodstuffs.

(Method for Producing Sheet Material)

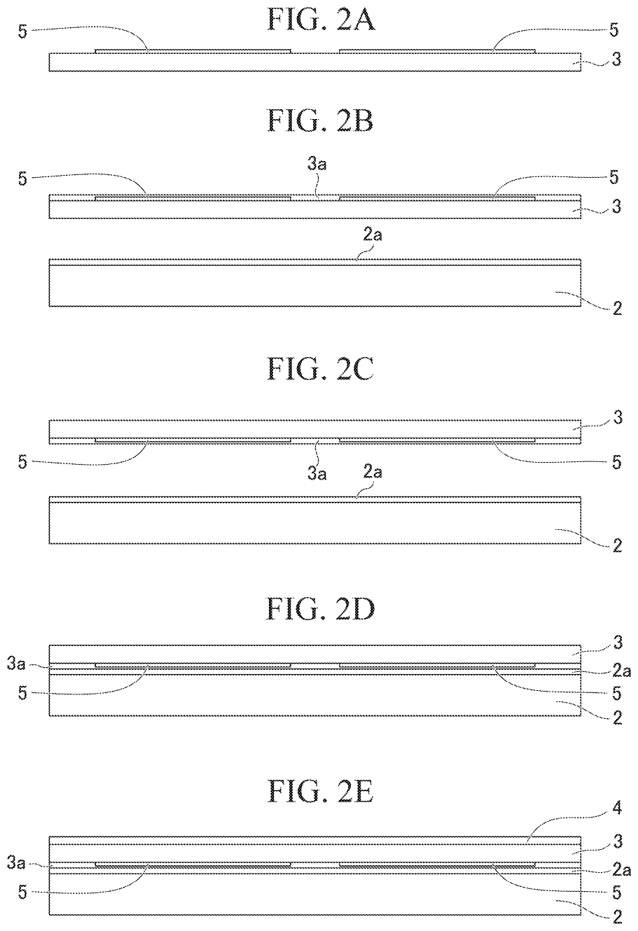

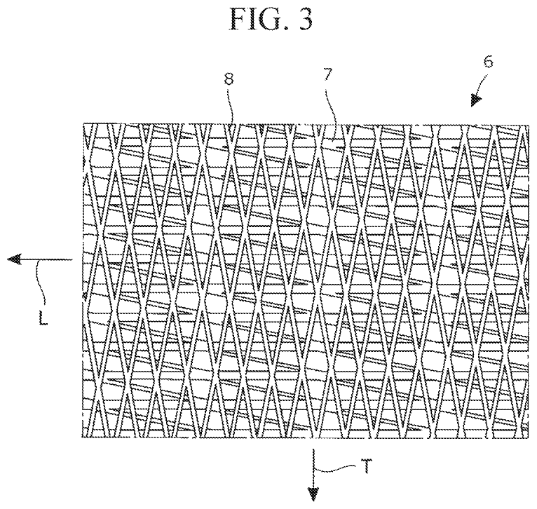

FIGS. 2A to 2E are schematic diagrams showing, in a stepwise manner, a method for producing the sheet material 1 shown in FIGS. 1A and 1B.

First, printing is performed on one face of a polyamide-based resin film 3 using a gravure printing machine or the like, and a printed portion 5 is formed (FIG. 2A). Next, one face of a reticular structure 2 is subjected to a corona treatment, thereby a modification layer 2a having a wetting index of 35 dynes or higher is formed, and a similar modification layer 3a is also formed by subjecting the face of the polyamide-based resin film 3 on which the printed portion 5 has been formed, to a corona treatment (FIG. 2B). Next, the reticular structure 2 and the polyamide-based resin film 3 are superposed such that the modification layers 2a and 3a face each other, and the two are bonded together by a thermal lamination method (FIG. 2C). In this thermal lamination method, the reticular structure 2 and the polyamide-based resin film 3 in a superposed state are passed through between a pair of heating rolls disposed to face each other, thereby the linear low-density polyethylene of the reticular structure 2 is melted at a temperature of about 100° C. to 130° C., and the two are bonded together by using this molten polyethylene as an adhesive layer (FIG. 2D). Lastly, on the other face of the polyamide-based resin film 3, that is, on the face facing the outer side after the reticular structure 2 and the polyamide-based resin film 3 are bonded together, for example, an ink including a Medium as a main component, or a resin material containing fluorine is applied, and a resin layer 4 is formed (FIG. 2E).

According to the present embodiment, the reticular structure 2 includes two or more uniaxially oriented bodies, each uniaxially oriented body including a thermoplastic resin layer; and an adhesive layer laminated on at least one face of the thermoplastic resin layer, and these two or more uniaxially oriented bodies are laminated by means of an adhesive layer or are woven such that the respective axes of orientation thereof intersect with each other.

First, the layer configuration of the uniaxially oriented bodies that constitute the reticular structure 2, and the compositions of the respective layers will be explained. A uniaxially oriented body includes a thermoplastic resin layer; and an adhesive layer laminated on at least one face of the thermoplastic resin layer.

The thermoplastic resin layer is a layer containing a thermoplastic resin as a main component. Examples of the thermoplastic resin include polyolefins such as polyethylene and polypropylene, and copolymers thereof, which have satisfactory fiber splittability, and the thermoplastic resin is preferably a high-density polyethylene. The thickness of the thermoplastic resin layer is not particularly limited, and the thickness can be determined as appropriate by a person ordinarily skilled in the art such that in a case in which the thickness of the adhesive layer is adjusted to the desired range that will be described below, a predetermined weight per unit area can be attained. The thickness of the thermoplastic resin layer can be adjusted to be approximately 5 to 70 μm, and it is preferable to adjust the thickness to 10 to 60 μm. Meanwhile, this thickness is the layer thickness obtainable after performing uniaxial orientation.

The adhesive layer is a layer containing a thermoplastic resin having a melting point that is lower than the above-mentioned thermoplastic resin, as a main component. The difference between the melting point of the adhesive layer and the melting point of the thermoplastic resin layer needs to be 5° C. or more for reasons related to production, and the difference is preferably 10° C. to 50° C.

It is preferable that the thermoplastic resin that constitutes the adhesive layer is polymerized using a metallocene catalyst. A metallocene catalyst is a catalyst of a kind referred to as so-called single site catalyst, in which active points are relatively homogeneous, and is a catalyst containing at least a transition metal compound of Group IV of the Periodic Table of Elements, the transition metal compound including a ligand having a cyclopentadienyl skeleton. Representative examples include metallocene complexes of transition metals, for example, catalysts obtainable by reacting a biscyclopentadienyl complex of zirconium or titanium with methylaluminoxane as a co-catalyst, and the catalysts are homogeneous or non-homogeneous catalysts obtained by variously combining a variety of complexes, co-catalysts, carriers, and the like. Examples of the metallocene catalysts include those known in Japanese Unexamined Patent Application, First Publication No. 558-19309, Japanese Unexamined Patent Application. First Publication No. S59-95292, Japanese Unexamined Patent Application, First Publication No. S59-23011. Japanese Unexamined Patent Application, First Publication No. S60-35006, Japanese Unexamined Patent Application, First Publication No. S60-35007, Japanese Unexamined Patent Application, First Publication No. S60-35008, Japanese Unexamined Patent Application, First Publication No. S60-35009, Japanese Unexamined Patent Application, First Publication No. S61-130314, Japanese Unexamined Patent Application, First Publication No. H3-163088, and the like.

A thermoplastic resin can be obtained by copolymerizing ethylene or propylene and an α-olefin by a production process such as a gas phase polymerization method, a slurry polymerization method, or a solution polymerization method, in the presence of such a metallocene catalyst. For the copolymer, it is preferable to use an α-olefin having 4 to 12 carbon atoms. Specific examples include butene, pentene, hexene, peptene, octene, nonene, and decene.

The thickness of the adhesive layer is 2 to 10 μm, preferably 2 to 9 μm, and more preferably 2 to 7 μm. When this thickness is less than 2 μm, a satisfactory adhesive force cannot be obtained. On the other hand, when the thickness is more than 10 μm, as a result, the tensile strength is decreased, the adhesive layer becomes soft, and a sufficient effect as a reinforcing material is not obtained. Meanwhile, this thickness is the layer thickness obtainable after performing uniaxial orientation.

The resins that respectively constitute the thermoplastic resin layer and the adhesive layer may include resins other than the above-described main components, such as polypropylene and polyethylene, to the extent that do not impair the characteristics of the layers, and may also include known additives. Examples of the additives include an oxidation inhibitor, a weather-proofing agent, a lubricating agent, an anti-blocking agent, an antistatic agent, an antifogging agent, an anti-dripping agent, a pigment, and a filler.

A uniaxially oriented body is obtained by uniaxially orienting a multilayer film having such a composition and such a layer configuration. The uniaxially oriented body may be, for example, a uniaxially oriented reticular film or a uniaxially oriented tape. The reticular structure according to the invention is formed by laminating or weaving at least two uniaxially oriented bodies, and the at least two uniaxially oriented bodies are laminated or woven such that the axes of orientation thereof intersect with each other. At this time, the two uniaxially oriented bodies may have the same composition and layer configuration, or may have different compositions and layer configurations. Depending on the characteristics of the uniaxially oriented bodies, the reticular structure may be a reticular nonwoven fabric or may be a woven fabric. Furthermore, the state in which the axes of orientation intersect with each other may be a state of being almost orthogonally intersecting, or may be a state of intersecting at a predetermined angle. Even in a case in which three or more uniaxially oriented bodies are laminated, it is desirable that the axes of orientation of the three or more uniaxially oriented bodies intersect with one another at predetermined angles. In the following description, embodiments of the uniaxially oriented bodies and embodiments of the reticular structure based on combinations of the uniaxially oriented bodies will be explained.

(First Reticular Structure: Nonwoven Fabric Having Split Web and Slit Web Laminated Together)

FIG. 3 shows a reticular nonwoven fabric as an example of the reticular structure according to an embodiment of the invention. The reticular nonwoven fabric 6 shown in FIG. 3 is a product in which a uniaxially oriented body obtained by splitting a longitudinally uniaxially stretched multilayer film and then widening the split multilayer film, and a uniaxially oriented body obtained by forming slits in a multilayer film in the width direction and then uniaxially stretching the multilayer film in the width direction, are laminated such that the directions of orientation are approximately orthogonally intersecting with each other. To be more specific, the reticular nonwoven fabric 6 is formed such that the axis of orientation L of a split web 7, which is an example of the uniaxially oriented body, and the axis of orientation T of a slit web 8, which is another example of the uniaxially oriented body, are warp-weft laminated so as to intersect with each other. Then, the contact areas between adjacent split web 7 and slit web 8 are face-bonded.

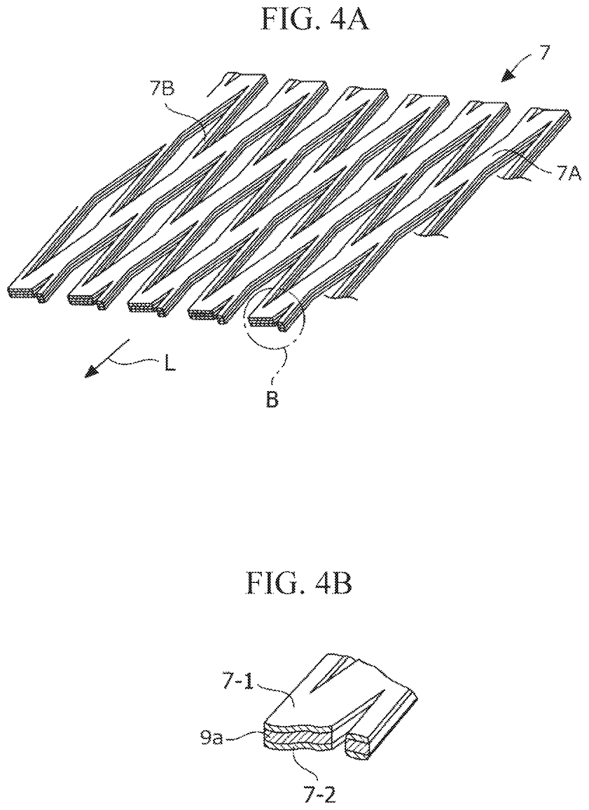

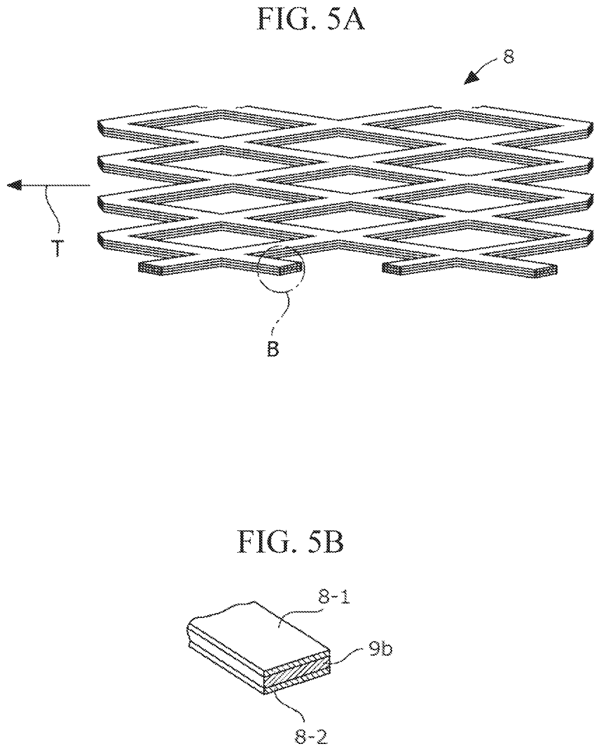

FIGS. 4A and 4B and FIGS. 5A and 5B respectively show a split web 7 and a slit web 8 that constitute the reticular nonwoven fabric 6 shown in FIG. 3. The split web 7 shown in FIG. 4A is a uniaxially oriented reticular film formed by uniaxially stretching a multilayer film, in which a linear low-density polyethylene layer is laminated on one face or both faces of a thermoplastic resin layer, in the longitudinal direction (axial direction of the axis of orientation L of the split web 7), splitting the stretched film in the longitudinal direction, and widening the split film.

The split web 7 as an example of the uniaxially oriented body formed from a reticular film can be produced by a production method such as multilayer inflation molding or a multilayer T-die method. Specifically, a multilayer film in which a linear low-density polyethylene layer synthesized using a metallocene catalyst as a preferred example of linear low-density polyethylene is laminated on both faces of a thermoplastic resin layer, is formed. In the following present specification, a linear low-density polyethylene layer polymerized using a metallocene catalyst is also referred to as metallocene LLDPE layer. This multilayer film is stretched at least to three times the original length in the longitudinal direction and then the multilayer film is split in a cross-stitch shape in the same direction using a splitter (split treatment) to obtain a reticular film, the reticular film is widened to a predetermined width, and thus the split web is formed. Stem fibers 7A and branch fibers 7B are formed by the widening, and the reticular body as shown in the diagram is formed. This split web 7 has relatively high strength in the longitudinal direction over the entirety in the width direction.

The split web 7 has, as shown in FIG. 4B, a three-layer structure having a thermoplastic resin layer 9a; and metallocene LLDPE layers 7-1 and 7-2 having a lower melting point than this thermoplastic resin layer 9a laminated on both faces of the thermoplastic resin layer 9a. Any one of the metallocene LLDPE layers 7-1 and 7-2 functions as a mutual adhesive layer between webs when the split web 7 is warp-weft laminated together with the slit web 8 at the time of forming the reticular nonwoven fabric 6.

The slit web 8 shown in FIG. 5A is a reticular film formed by inserting a large number of slits into a multilayer film in which metallocene LLDPE layers are laminated on both faces of a thermoplastic resin layer, in the transverse direction (axial direction of the axis of orientation T of the slit web 8), and then uniaxially stretching the multilayer film in the transverse direction. To be more specific, the slit web 8 is formed by forming intermittent slits such as cross-stitches parallelly using, for example, a hot blade in the transverse direction (width direction) in portions of the multilayer film excluding both ear portions, and then stretching the multilayer film in the transverse direction. This slit web 8 has relatively high strength in the transverse direction.

The slit web 8 has, as shown in FIG. 5B, a three-layer structure having a thermoplastic resin layer 9b; and metallocene LLDPE layers 8-1 and 8-2 having a lower melting point than this thermoplastic resin on laminated both faces of the thermoplastic resin layer 9b. Any one of these metallocene LLDPE layers 8-1 and 8-2 functions as a mutual adhesive layer between webs when the slit web 8 is warp-weft laminated together with the split web 7 at the time of forming the reticular nonwoven fabric 6.

Regarding the shape of the slit web, in addition to the shapes shown in FIGS. 5A and 5B, a uniaxially oriented body including stem fibers extending in parallel to one another; and branch fibers connecting between adjacent stem fibers, in which the stem fibers are arranged roughly unidirectionally, the uniaxially oriented body being obtainable by forming a large number of slits in the width direction in a raw web film having a configuration similar to that of the split web 7 and then stretching the raw web film in the width direction at a stretch ratio similar to that of the split web 7, that is, a slit web having a pattern obtainable by rotating the split web 7 by ±90° when viewed in a plan view, or a pattern analogous to this, can also be used as the uniaxially oriented reticular film.

(Second Reticular Structure: Woven Fabric Having Uniaxially Oriented Tapes Woven Together)

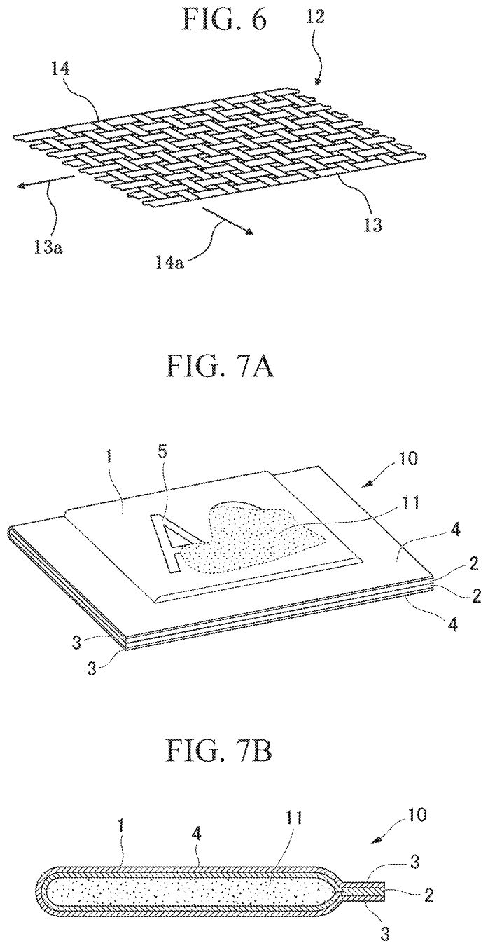

FIG. 6 shows a reticular woven fabric as another example of the reticular structure according to the present embodiment of the invention. The reticular woven fabric 12 shown in FIG. 6 is such that uniaxially oriented tapes 13 oriented in the direction of an axis 13a and uniaxially oriented tapes 14 oriented in the direction of an axis 14a that orthogonally intersects the axis 13a are mutually woven. In the woven fabric 12, uniaxially oriented tapes 13 and 14 at the crossing and overlapping portions are face-bonded to each other.

### Second Embodiment

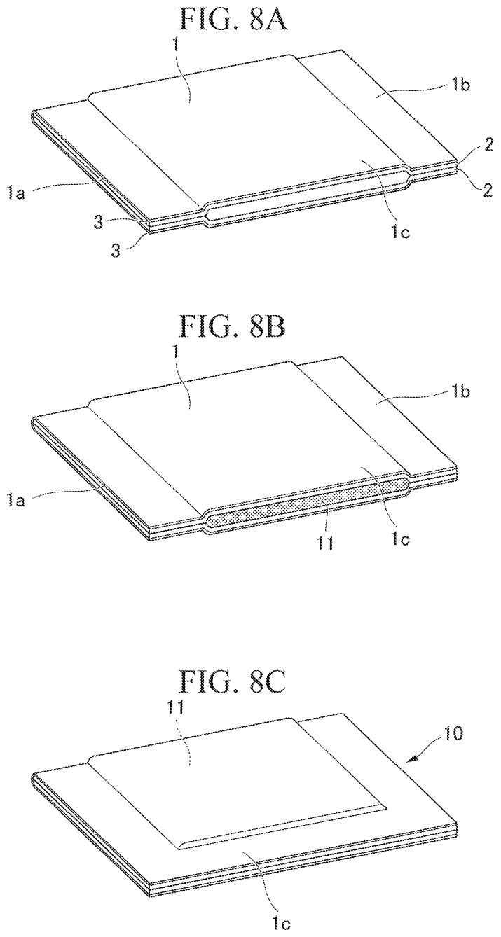

A second embodiment according to the invention will be explained by describing the embodiment in FIG. 7A to FIG. 8C.

FIGS. 7A and 7B show an example of an alcohol vaporization agent package 10 that uses the sheet material shown in FIGS. 1A and 1B. FIG. 7A is a perspective view of the alcohol vaporization agent package 10, and FIG. 7B is a cross-sectional view of FIG. 7A. In FIG. 7B, the modification layers 2a and 3a and the printed portion 5 are omitted, and the sheet material 1 is shown as a two-layer structure of a reticular structure 2 and a polyamide-based resin film 3.

The alcohol vaporization agent package 10 is a bag-shaped package that encloses an alcohol vaporization agent 11 and is heat-sealed. This alcohol vaporization agent package 10 is formed from a sheet material 1 having a laminated structure including a reticular structure 2 and a polyamide-based resin film 3. A printed portion 5 is formed on the polyamide-based resin film 3 at the laminated surface between the reticular structure 2 and the polyamide-based resin film 3. Then, the alcohol vaporization agent 11 is enclosed such that the reticular structure 2 side comes as an inner surface of the bag, the linear low-density polyethylene layer of the reticular structure 2 on the inner surface side of the bag is used as a heat-seal layer to adhere the inner surfaces, and thus a bag shape is formed. FIG. 3 shows an example in which a sheet material 1 is folded and adhered along the remaining three sides 1a, 1b and 1e to seal the alcohol vaporization agent 11; however, it is also acceptable that two rectangular-shaped sheet materials 1 are adhered along the four sides.

FIGS. 8A to 8C are schematic diagrams showing, in a stepwise manner, a method for producing the alcohol vaporization agent package 10 shown in FIGS. 7A and 7B. First, a sheet material 1 is produced by the method described above, subsequently a laminated raw web of the sheet material 1 is slit into a prescribed bag size, then the laminated raw web thus slit is folded in half, and the two sides 1a and 1b orthogonally intersecting with the fold mark are adhered by thermal fusion of the linear low-density polyethylene layer of the folded and overlapped reticular structure 2, and thus the sheet material 1 is formed into a bag shape (FIG. 8A). At this time, the sheet material 1 is folded such that the face at which the reticular structure 2 is exposed comes to the inner side, the linear low-density polyethylene layer of the reticular structure 2 is used as a heat-seal layer, and the two sides 1a and 1c that orthogonally intersect the fold mark are adhered. Next, the inner side of the bag-shaped sheet material 1 is filled with the alcohol vaporization agent 11 (FIG. 8B). Finally, the one remaining side 1b that is parallel to the fold mark is adhered, in a state of enclosing the alcohol vaporization agent 11, by thermal fusion of the linear low-density polyethylene layer of the reticular structure 2, and thereby the alcohol vaporization agent 11 is encapsulated (FIG. 8C).

As such, in a case in which the alcohol vaporization agent package 10 for food preservation is produced using the sheet material 1, a resin layer 4 is formed on a face of the polyamide-based resin film 3, the face being on the opposite side of the reticular structure 2. Even if oligomers included in the polyamide-based resin film 3 exude from the polyamide-based resin film 3 along with alcohol when alcohol permeates through the sheet material 1, the resin layer 4 formed by applying, for example, an ink including a Medium as a main component or by applying a fluororesin on the surface of the polyamide-based resin film 3, blocks permeation of the oligomers while permeating the alcohol. Therefore, precipitation of the oligomers on the surface of the sheet material 1 is prevented. Thereby, a white precipitated powder of the oligomers will not stick to the foodstuffs that are packaged together in the alcohol vaporization agent package, and therefore, the value of the article will not be lowered.

Furthermore, the resin layer 4 has an effect of imparting strength to the polyamide-based resin film 3 and preventing so-called “back split” at the time of folding the sheet material 1.

### Examples

As the sheet material 1, for example, a sheet having an alcohol permeability of 150 g/m²·24 h 25° C.·84% RH or higher, in which delamination caused by alcohol is not recognized even after being subjected to the following test, was used.

### (Evaluation of Alcohol Permeability)

Packages 10A, 10B, and 10C (size: 10 cm×10 cm on four sides) each including 5 grams of an alcohol vaporization agent were produced, and those packages were left to stand indoor for 24 hours at an air temperature of 25° C. and a humidity of 84%. Subsequently, the weight of each of the packages was measured, the weight was compared with the initial weight, and the difference was estimated as the amount of alcohol vaporized in 24 hours.

### (Test on Delamination Caused by Alcohol)

The packages 10A, 10B, and 10C were immersed in a 95% ethanol solution for 24 hours, and then the presence or absence of delamination was investigated.

A sheet material 1A was produced by employing WARIFU (registered trademark) manufactured by JX Nippon ANCI Corporation as the reticular structure 2, HARDEN (registered trademark) manufactured by Toyobo Co., Ltd. as the polyamide-based resin film 3, and a Medium (NB300, alcohol-resistant) manufactured by Dainichiseika Color & Chemicals Manufacturing Co., Ltd. as a material for forming the resin layer 4. Furthermore, an alcohol vaporization agent package 10A was produced using the sheet material.

On the occasion of forming the resin layer 4 by using the Medium as a material, 60 to 70 (weight %) of the Medium (product name: NB300 Medium) was mixed with 30 to 40 (weight %) of a diluting solvent (LAMIK F-No. 2), and the mixture was applied on the polyamide-based resin film 3 in a coating amount of 7 g/m². At that time, a working life of 8 hours was secured, and aging (aging) of 24 hours or longer at a temperature of 40° C. was carried out.

Furthermore, a sheet material 1B was produced by employing an overprint varnish (hereinafter, OP varnish) instead of a Medium, and an alcohol vaporization agent package 10B was produced using the sheet material. Regarding the OP varnish, a dilution diluted with 40% to 50% by weight of a diluting solvent was used, and the coating amount was set to 4 to 6 g/m².

Furthermore, a sheet material 1C having a fluororesin layer formed therein instead of a Medium was produced, and an alcohol vaporization agent package 10C was produced using the sheet material. On the occasion of forming the fluororesin layer, a water and oil repellant (AsahiGuard E-Series AG-E070 manufactured by AGC Asahi Glass, Inc.) was diluted with 10% by weight of a food additive (AMANOL N88 manufactured by Amakasu Chemical Industries, Ltd.), and the water and oil repellant thus diluted was applied on the polyamide-based resin film 3 in a coating amount of 4 to 6 g/m².

For these alcohol vaporization agent packages 10A, 10B, and 10C, the presence or absence of precipitation of oligomers under the following conditions was investigated. That is, a sample was inserted into a bag having barrier properties, and a process with a period of 24 hours of leaving the bag to stand for 7 hours at a temperature of 10° C. and subsequently for 17 hours at a temperature of 50° C. was repeated for 30 days. Subsequently, an investigation was conducted to see whether there was precipitation of oligomers (white fine powder) on the package surface. As a result, in package 10B that employed the OP varnish, precipitation of oligomers was recognize; however, in package 10A that employed a Medium and package 10C having a fluororesin layer formed therein, precipitation of oligomers was not recognized.

### REFERENCE SIGNS LIST

1: Sheet material
2: Reticular structure
3: Polyamide-based resin film
2a and 3a: Modification layer
4: Resin layer
5: Printed portion
6: Reticular nonwoven fabric
7: Split web
8: Slit web
10: Alcohol vaporization agent package
11: Alcohol vaporization agent

1. A sheet material, comprising:
a sheet-like substrate material;
a polyamide-based resin film laminated on one face of the substrate material; and
a resin layer formed on a face of the polyamide-based resin film, the face being on the opposite side of the substrate material,
wherein the resin layer prevents precipitation of oligomers included in the polyamide-based resin film.

2. The sheet material according to claim 1, wherein the resin layer includes a Medium or a fluororesin.

3. The sheet material according to claim 1, wherein the substrate material is a woven fabric or a nonwoven fabric.

4. The sheet material according to claim 3, wherein the nonwoven fabric is a reticular structure.

5. An alcohol vaporization agent package, comprising:
a package main body in which a sheet material is formed, the package main body being processed into a bag shape; and
an alcohol vaporization agent enclosed in the package main body,
the sheet material including:
a sheet-like substrate material;
a polyamide-based resin film laminated on one face of the substrate material; and
a resin layer formed on a face of the polyamide-based resin film, the face being on the opposite side of the substrate material,
wherein the resin layer prevents precipitation of oligomers included in the polyamide-based resin film on the sheet material surface when alcohol vaporizing from the alcohol vaporization agent permeates through the polyamide-based resin film.

6. The alcohol vaporization agent package according to claim 5, wherein the resin layer includes a Medium or a fluororesin.

7. The alcohol vaporization agent package according to claim 5, wherein the substrate material is a woven fabric or a nonwoven fabric.

8. The alcohol vaporization agent package according to claim 7, wherein the nonwoven fabric is a reticular structure.
